(19) United States
(12) Patent Application Publication
(10) Pub. No.: US 2025/0177919 A1
(43) Pub. Date: Jun. 5, 2025

(54) METHANE REMOVAL DEVICE

(71) Applicant: Isuzu Motors Limited, Yokohama-shi (JP)

(72) Inventors: Teppei OOHORI, Fujisawa-shi (JP); Kohei OKA, Fujisawa-shi (JP)

(73) Assignee: Isuzu Motors Limited, Yokohama-shi (JP)

(21) Appl. No.: 18/912,635

(22) Filed: Oct. 11, 2024

(30) Foreign Application Priority Data
Dec. 4, 2023 (JP) 2023-204809

(51) Int. Cl. B01D 53/86; B01D 53/04; B01D 53/75; B01J 20/18; B01J 20/30; B01J 29/70

(52) U.S. Cl. CPC B01D 53/864; B01D 53/0446; B01D 53/75; B01J 20/186; B01J 20/3085; B01J 29/7007; B01D 2251/104; B01D 2253/108; B01D 2255/502; B01D 2257/304; B01D 2257/406; B01D 2257/556; B01D 2257/7025; B01D 2257/708

(57) ABSTRACT

An object of the present disclosure is to provide a methane removal device that efficiently removes methane from various exhaust gases.

For this reason, the methane removal device includes a housing provided with a suction port and a discharge port, an adsorption section provided in the housing and supporting a BEA-type zeolite that includes ion-exchanged cobalt, and an ozone supply device that supplies ozone between the suction port and the adsorption section.

### CROSS REFERENCE TO RELATED APPLICATIONS

This application claims the benefit of priority of Japanese Patent Application No. 2023-204809, filed on Dec. 4, 2023, the contents of which are incorporated by reference as if fully set forth herein in their entirety.

### TECHNICAL FIELD

The present disclosure relates to a device for removing methane from a gas.

### BACKGROUND ART

Exhaust gas from an automobile, various plants, agricultural and livestock facilities, a waste disposal plant, a sewage treatment plant, and the like contains methane. Methane is one type of greenhouse gases, and the global warming potential (GWP) of methane is 25 compared to 1 for carbon dioxide.

Exhaust gas containing a high concentration of methane is treated by combustion of methane itself or combustion with the addition of a fuel, but exhaust gas containing a low concentration of methane is possibly discharged as it is without treatment. Further, methane generated by eructation of ruminants in the agricultural and livestock facilities or by anaerobic fermentation of excreta is basically discharged as it is without treatment.

### SUMMARY OF INVENTION

### Technical Problem

Various greenhouse gases are required to be reduced as measures against global warming, and it is desired to remove methane from various exhaust gases and the like as well, but the technique for efficiently decomposing and removing methane from exhaust gas has not been put into practical use.

An object of the present disclosure is to provide a methane removal device that efficiently removes methane from various exhaust gases and the like.

### Solution to Problem

A methane removal device of the present disclosure includes: a housing provided with a suction port and a discharge port; an adsorption section that is provided in the housing and supports a BEA-type zeolite including ion-exchanged cobalt; and an ozone supply device that supplies ozone between the suction port and the adsorption section.

### Advantageous Effects of Invention

According to the methane removal device of the present disclosure, methane can be efficiently decomposed by the catalytic action in the adsorption section. Further, since methane is adsorbed on the adsorption section and is decomposed by ozone, the contact opportunity between methane and ozone increases, and thus, decomposition and removal of methane can be performed efficiently.

### BRIEF DESCRIPTION OF DRAWINGS

FIG. 1 is a diagram illustrating a main part of a methane removal device;

FIG. 2 is a diagram illustrating the entire methane removal device; and

FIG. 3 is a diagram illustrating a variation of the methane removal device.

### DESCRIPTION OF EMBODIMENTS

Hereinafter, a methane removal device according to an embodiment of the present disclosure will be described in detail with reference to the accompanying drawings. Note that the embodiments described below indicate all comprehensive or specific examples. Each drawing is a schematic view and is not necessarily a strict illustration. Further, in each drawing, the same symbol is attached to a substantially identical components, and redundant explanations are omitted or simplified in some cases.

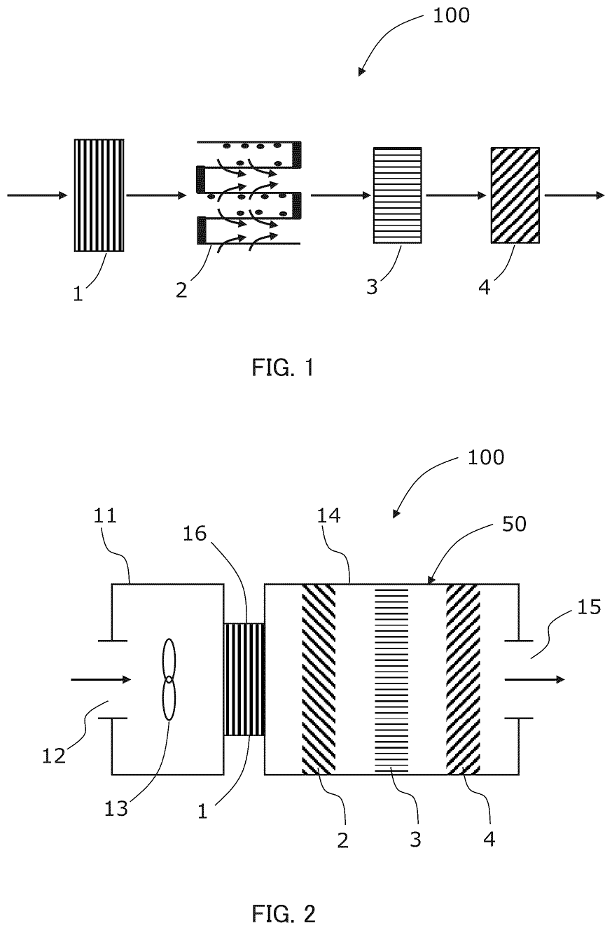

FIG. 1 schematically illustrates a main part of methane removal device 100 according to the present disclosure. The gas to be treated flows and is treated through methane removal device 100 from left to right along the arrows in the drawing.

Reference numeral 1 refers to an ozone supply device that supplies ozone to the gas to be treated. Although the system of ozone supply device 1 is not limited, a silent discharge system, an ultraviolet lamp system, an electrolysis system, or the like can be adopted. The generated ozone is mixed with the gas to be treated and flows.

Reference numeral 2 refers to a particle collection section that collects fine particles in the gas to be treated, and further absorbs unwanted components other than methane to decompose and remove the components. The unwanted components include ammonia, hydrogen sulfide, siloxanes, volatile organic compounds (VOC), and fine particles such as soot.

The material of particle collection section 2 is preferably a material that is not degraded by ozone, and a mesh or porous filter is molded using glass fiber or ceramics as the material. Further, it is desirable that a zeolite of a BEA type, a MOR type, a FER type, an MFI type, a FAU type, a CHA type, or an LTA type be supported on this filter as a catalyst for decomposing unwanted components using ozone, and particularly a BEA-type zeolite is desirable from the viewpoints of economy and the catalytic function.

Reference numeral 3 refers to an adsorption section that adsorbs methane in the gas to be treated, and decomposes and removes the methane. Absorption section 3 is composed of a material that is not degraded by ozone, such as glass fiber or ceramics. The material is shaped into a form like a honeycomb, corrugation, mesh, porous body, or expander to function as a catalyst support. It is desirable to form absorption section 3 by a zeolite of a BEA type, a MOR type, a FER type, an MFI type, a FAU type, a CHA type, an LTA type, or the like being supported on this catalyst support.

As a zeolite of absorption section 3, it is desirable to adopt a zeolite in which a metal such as Ti, V, Cr, Mn, Fe, Co, Ni, Cu, Zn, Y, Zr, Nb, Mo, Sn, a lanthanoid, Ta, W, or Bi, is ion-exchanged, and is particularly desirable to adopt a BEA-type zeolite in which Co is ion-exchanged because a BEA-type zeolite can most efficiently decompose methane.

Reference numeral 4 refers to an ozone decomposition section that decomposes ozone in the gas to be treated. Ozone decomposition section 4 decomposes ozone remaining in the gas to be treated from which methane or the like has been decomposed and removed. Although the material is not limited, activated carbon, an alumina compound, a manganese-based catalyst, or the like can be adopted.

FIG. 2 schematically illustrates the overall structure of methane removal device 100 according to the present disclosure. The gas to be treated flows and is treated through methane removal device 100 from left to right along the arrows in the drawing. Housing 50 of methane removal device 100 includes: suction chamber 11 including suction port 12 through which the gas to be treated flows; oxidation chamber 14 including discharge port 15 through which the treated gas is discharged; and communicating pipe 16 that communicates between suction chamber 11 and oxidation chamber 14.

Inside suction chamber 11, fan 13 for suctioning the gas to be treated through suction port 12 is provided. Ozone supply device 1 is provided inside communicating pipe 16, and supplies ozone to the inside of communicating pipe 16. Particle collection section 2, adsorption section 3, and ozone decomposition section 4 are provided in oxidation chamber 14 in this order from the upstream side to the downstream side of the flow of the gas to be treated.

Next, the action of methane removal device 100 will be described. When fan 13 rotates, the gas to be treated containing methane is suctioned into suction chamber 11 through suction port 12 and is sent to communicating pipe 16. When ozone supply device 1 in communicating pipe 16 is driven, ozone is generated in communicating pipe 16, and ozone is mixed with the gas to be treated.

The gas to be treated containing ozone is sent to oxidation chamber 14 and comes into contact with particle collection section 2. In particle collection section 2, fine particles in the gas to be treated are collected and separated. Further, due to the catalytic action of the BEA-type zeolite or the like in particle collection section 2, unwanted components such as ammonia, hydrogen sulfide, siloxanes, and VOC in the gas to be treated are decomposed and treated with ozone. This makes it possible to prevent the fine particles and unwanted components from reaching adsorption section 3 placed on the downstream side, and to eliminate the risk of inhibiting the decomposition reaction of methane in adsorption section 3.

Subsequently, when the gas to be treated, from which the fine particles and unwanted components have been separated and removed, comes into contact with adsorption section 3, methane is adsorbed on a BEA-type zeolite in which cobalt ions are ion-exchanged. Then, methane is decomposed by ozone according to the following formula through the catalytic action of the BEA-type zeolite.

CH₄+4O₃→CO₂+2H₂O+4O₂

Since methane is adsorbed in adsorption section 3, the contact opportunity for methane to come into contact with ozone increases, and further, since adsorption section 3 contains a BEA-type zeolite in which Co is ion-exchanged, the decomposition of methane is promoted by the catalytic action of adsorption section 3.

The ozone remaining unused for the decomposition of methane in adsorption section 3 is decomposed into oxygen in ozone decomposition section 4. The gas to be treated, from which methane and other impurities have been decomposed and removed, is discharged from discharge port 15.

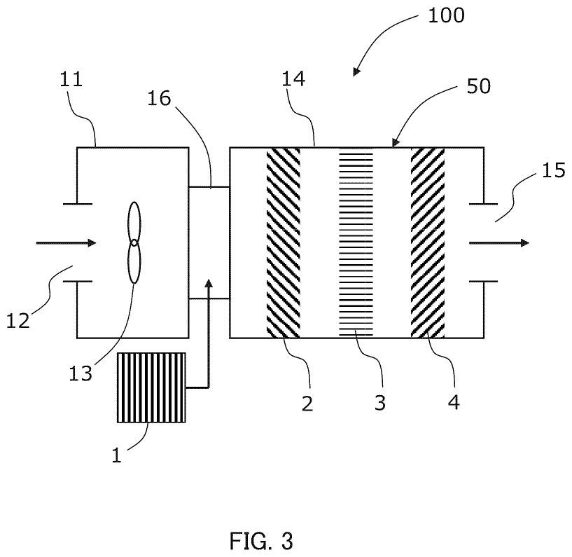

FIG. 3 illustrates a variation of methane removal device 100. In this example, ozone supply device 1 is provided outside communicating pipe 16 instead of inside communicating pipe 16, and ozone is supplied from the outside of communicating pipe 16. This structure allows the flow of the gas to be treated in communicating pipe 16 to be smoother. Further, the type and size of ozone supply device 1 are not limited to the diameter of communicating pipe 16 or the like.

In the embodiment and variation described above, fan 13 is provided on the upstream side of ozone supply device 1, adsorption section 3, and the like, but fan 13 may be provided between ozone supply device 1 and adsorption section 3 or on the downstream side of adsorption section 3.

Further, in the embodiment and variation described above, fan 13 is provided in housing 50 of methane removal device 100, but the configuration may also be such that the gas to be treated is pressurized and sent into methane removal device 100 from outside methane removal device 100.

The embodiment and variation described above can be adopted in any combination.

### INDUSTRIAL APPLICABILITY

Methane can be efficiently decomposed and removed, and the greenhouse gas can be reduced.

### REFERENCE SIGNS LIST

1 Ozone supply device
2 Particle collection section
3 Adsorption section
4 Ozone decomposition section
11 Suction chamber
12 Suction port
13 Fan
14 Oxidation chamber
15 Discharge port
16 Communicating pipe
50 Housing
100 Methane removal device

1. A methane removal device, comprising:
a housing provided with a suction port and a discharge port;
an adsorption section that is provided in the housing and supports a BEA-type zeolite including ion-exchanged cobalt; and
an ozone supply device that supplies ozone between the suction port and the adsorption section.

2. The methane removal device according to claim 1, wherein a fan that suctions a gas to be treated from the suction port and discharges the gas to be treated from the discharge port is provided in the housing.

3. The methane removal device according to claim 1, wherein the ozone supply device is provided inside the housing.

4. The methane removal device according to claim 1, wherein the ozone supply device is provided outside the housing.

5. The methane removal device according to claim 1, further comprising an ozone decomposition section between the adsorption section and the discharge port.

6. The methane removal device according to claim 1, wherein a particle collection section that collects fine particles included in the gas to be treated is provided between the ozone supply device and the adsorption section.

7. The methane removal device according to claim 6, wherein the particle collection section includes zeolite.

8. The methane removal device according to claim 7, wherein the zeolite is a BEA-type zeolite.
